(19) United States
(12) Patent Application Publication
(10) Pub. No.: US 2015/0285667 A1
(43) Pub. Date: Oct. 8, 2015

(54) Method and Apparatus for Dispensing Sweetener

(71) Applicants: Luke Michas, Hendersonville, TN (US); Brandon Heller, Nashville, TN (US)

(72) Inventors: Luke Michas, Hendersonville, TN (US); Brandon Heller, Nashville, TN (US)

(21) Appl. No.: 14/248,262

(22) Filed: Apr. 8, 2014

(51) Int. Cl. G01F 11/46; B65D 83/06

(52) U.S. Cl. CPC G01F 11/46; B65D 83/06

(57) ABSTRACT

A sweetener dispensing system is provided herein. The system includes a support stand, and a plurality of sweetener dispensers supported by the support stand. Each of the sweetener dispensers comprises a canister for holding a granular material such as an artificial sweetener or a natural granular sweetener. A funnel is disposed below the bottom end and of the canister. Each dispenser has its own lever, and a lower spout defining an opening below the funnel. Each dispenser is configured such that rotation of the lever causes a bore of a respective cylinder to at least partially align with an opening in the bottom end of the corresponding canister and with the opening in the corresponding lower spout so that sweetener may be gravitationally dispensed from the dispenser. A method of dispensing a sweetener is also provided herein.

### CROSS REFERENCE TO RELATED APPLICATIONS

Not applicable

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field of the Invention

The present invention relates to dispensing systems. More specifically, the embodiments described herein relate to a method and apparatus for dispensing granular or particulate material including coffee grinds, sweeteners, sugar in the raw, nondairy creamer, and other beverage ingredients. The embodiments described herein also include an apparatus and method for dispensing predetermined amounts of such ingredients.

2. Technology in the Field of the Invention

In our health-conscious culture, many people choose to use raw sugar granules or artificial sweetener in their food. This is particularly true with respect to beverages such as coffee or tea.

In current practice, the consumer will acquire a sweetener in a small packet. Each packet must be separately torn open and its contents emptied into the cup. The result is that large quantities of packets must be placed on display by the retail store, and then handled by the consumer. The process of emptying the contents of the sweetener packets produces a messy counter top and a full trash bin.

Therefore, a need exists for an improved dispenser for a sweetener or other granular material. Further, a need exists for a system wherein multiple sweetener types may be individually dispensed into a beverage container without need of tearing open packets or throwing packets away.

### BRIEF SUMMARY OF THE INVENTION

A granular dispenser is first provided herein. The dispenser is preferably used for dispensing a sweetener. Common sweeteners include Splenda®, owned domestically by Johnson & Johnson of New Brunswick, N.J., and Sugar in the Raw owned by CPC Intellectual Property, Inc. of Brooklyn, N.Y.

In one aspect, the dispenser first includes a canister. The canister defines a body having upper and lower ends. The upper end is open for receiving a granular material, while the bottom end defines an opening for releasing the granular material. The granular material is released gravitationally upon movement of a lever.

The dispenser also includes a lid. The lid is configured to cover the upper end of the canister. In one aspect, the lid gravitationally rests around the upper end of the canister body. In another aspect, the lid pivots between a raised and open position, and a lowered and closed position.

The dispenser further has a funnel. The funnel is disposed below the bottom end of the canister, and is dimensioned to receive the bottom end of the canister. The funnel has an opening that is aligned with the opening of the bottom end of the canister.

The dispenser additionally includes an upper funnel mount. The funnel mount has a pair of generally concentric lips. A first lip supports a shoulder on the bottom end of the canister, while a second lip concentrically supports a shoulder around the opening of the funnel. The funnel mount includes an opening that aligns with the aligned openings in the bottom end of the canister and in the funnel.

The dispenser also has a flange. The flange extends from the upper funnel mount laterally from the aligned openings. Preferably, the flange is integral to the upper funnel mount. In one aspect, the flange is a horizontal base that supports a corresponding horizontal portion of the funnel.

The dispenser next includes a lever. The lever is designed to rotate, or pivot, between a raised position in which the granular material is held within the canister, and a lowered position in which the granular material is gravitationally dispensed from the canister. The lever preferably includes a handle and a cap. The cap may optionally be labeled.

The dispenser also includes a cylinder. The cylinder resides below the funnel. The cylinder is configured to rotate about a horizontal axis in response to movement of the lever. The cylinder has a bore that aligns with the opening in the bottom end of the canister and the opening in the funnel for receiving the granular material.

The dispenser further has a cylinder housing. The housing has a bore that is dimensioned to rotationally receive the cylinder. The housing supports the flange. In one embodiment, the housing includes a left housing cap residing on a left side of the cylinder housing, and a right housing cap residing on a right side of the cylinder housing. The left and right housing caps cover the cylinder within the cylinder housing.

The dispenser also has a lower spout. The lower spout defines an opening below the cylinder housing.

The dispenser preferably also includes a biasing member. The biasing member causes the lever to be biased in a position such that the bore of the cylinder is out of alignment with the opening in the bottom end of the canister and with the opening in the lower spout so that granular material may not be dispensed from the lower spout. Preferably, the biasing member is a spring that resides within the housing. Preferably, the spring causes the lever to be biased in a raised position, so that dispensing the granular material requires movement of the lever from its raised position to a lowered position.

In operation, rotation of the lever causes the bore of the cylinder to at least partially align with the opening in the bottom end of the canister and with the opening in the lower spout. In this way, granular material may be gravitationally dispensed through the lower spout.

A sweetener dispensing system is also provided herein. The system includes a plurality of the dispensers, in any of the embodiments described above. The system further includes a stand for supporting the plurality of dispensers in side-by-side relation.

In one embodiment, the stand comprises a free standing base having a plurality of openings. The openings are supported above a surface. Each opening is dimensioned to receive the funnel of a corresponding dispenser.

In another embodiment, the stand comprises a bracket. The bracket is dimensioned to be secured to a wall. The bracket has a plurality of openings, with each opening being dimensioned to receive the funnel of a corresponding dispenser.

In addition, a method of dispensing a sweetener is provided herein. The method includes providing a support stand, and then providing a plurality of sweetener dispensers. Each of the dispensers is configured according to the dispenser described above in any of its embodiments.

The method also includes placing the funnel of each dispenser into a corresponding opening along the stand. In this way, the dispensers are supported by the stand. The method then includes rotating the lever of a dispenser in order to dispense a sweetener. Rotation of the lever causes the bore of a respective cylinder to at least partially align with the opening in the bottom end of the corresponding canister and with the opening in the corresponding lower spout so that sweetener may be gravitationally dispensed from the lower spout.

In one embodiment, the method also includes labeling each canister with the identity of the sweetener in the body of the corresponding canister. The method may also include removing the lid of each canister, and filling each canister with the appropriate sweetener.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1A is a perspective view of a granular dispenser of the present invention, in one embodiment. Here, the dispenser is in an assembled form.

FIG. 1B is an exploded view of the granular dispenser of FIG. 1A. Various components are more clearly seen.

FIG. 2A is a partially exploded view of the cylinder housing, the cylinder and the lever components of the granular dispenser of FIG. 1A.

FIG. 2B is a further exploded view of the cylinder housing, the cylinder and the lever components of the granular dispenser of FIG. 1A.

FIG. 3A is a cross sectional view of the granular dispenser of FIG. 1A. Here, the canister has been filled with a sweetener. However, the lever is in a closed position so that no sweetener may be dispensed.

FIG. 3B is another cross sectional view of the granular dispenser of FIG. 1A. In this view, the lever is rotated into a lowered and open position so that sweetener may be dispensed.

FIG. 4 is a left side view of a dispenser under an embodiment.

FIG. 5 is a left front perspective view of a dispenser under an embodiment.

FIG. 6 is a back left perspective view of a dispenser under an embodiment.

FIG. 7 is a front view of a dispenser under an embodiment.

FIG. 8 is a front right perspective view of a dispenser under an embodiment.

FIG. 9 is a cross sectional view of a dispenser under an embodiment.

FIG. 10 is a top down view of a dispenser under an embodiment.

FIG. 11 is a front left perspective view of a plurality of dispensers mounted on a stand under an embodiment.

FIG. 12 is a left side view of a plurality of dispensers mounted on a stand under an embodiment.

FIG. 13 is a front view of a plurality of dispensers mounted on a stand under an embodiment.

FIG. 14 is a top down view of a plurality of dispensers mounted on a stand under an embodiment.

### DETAILED DESCRIPTION OF CERTAIN EMBODIMENTS

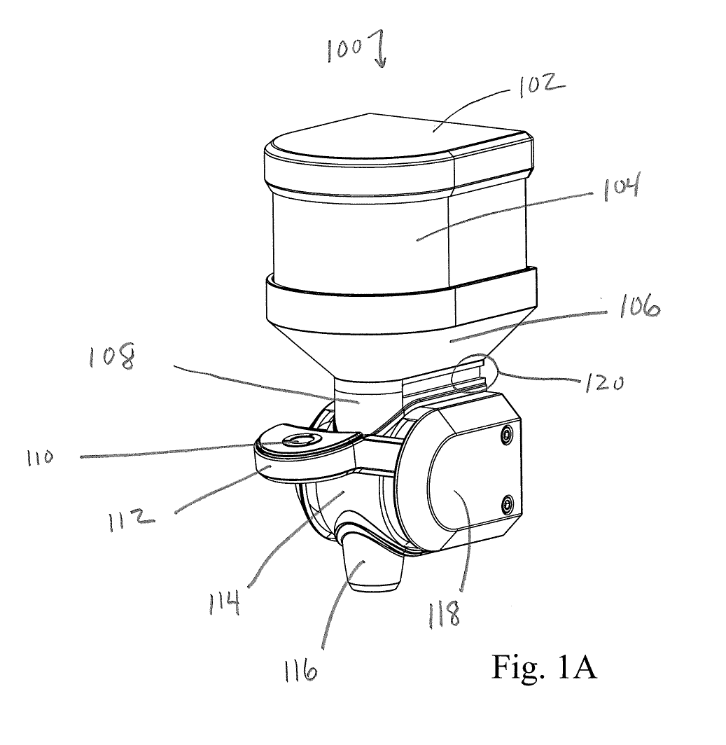

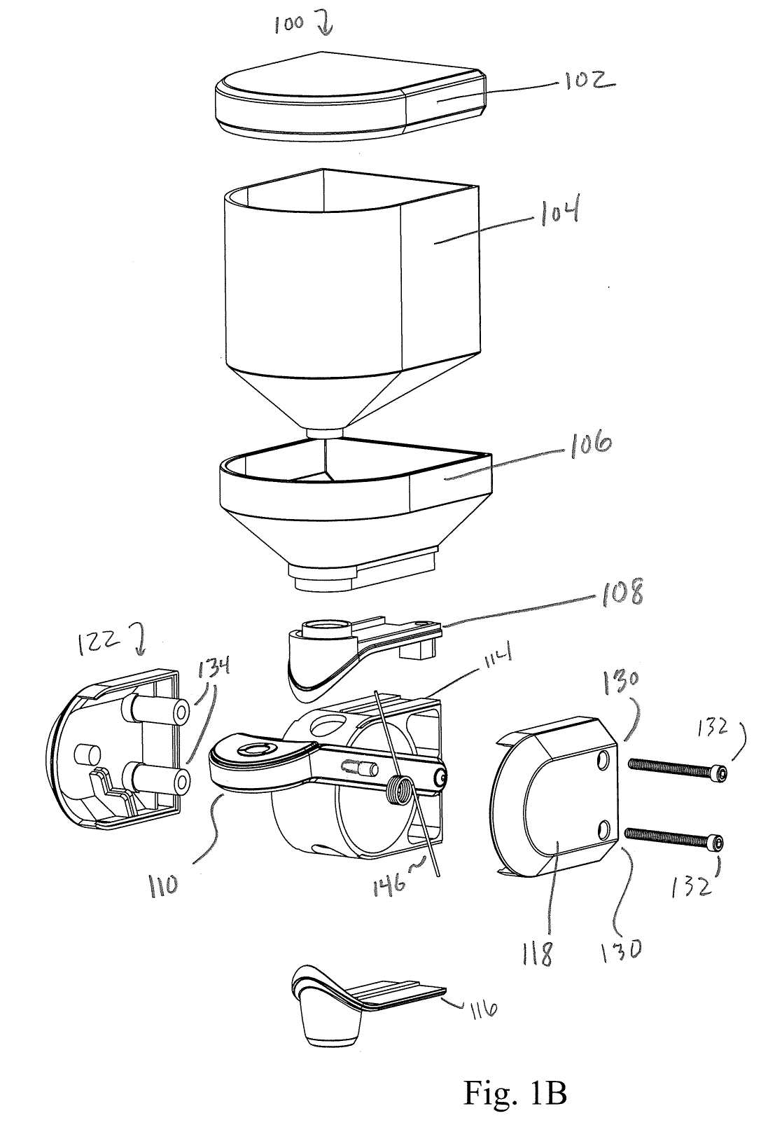

FIG. 1A shows an assembled view of a dispenser 100. The dispenser includes a canister lid 102, a refillable canister 104 and a funnel 106. A lower surface of the canister 104 is dimensioned to rest upon an upper interior surface of the funnel 106 (as further described below). The canister lid 102 sits atop the refillable canister 104 and keeps dust and debris out of canister. Gravity holds the lid 102 in place on top of the canister 104 under an embodiment. An upper funnel mount 108 resides between the funnel 106 and the cylindrical housing 114. The cylindrical housing features a right housing cap 118 and a left housing cap (not seen). A user of the dispenser 100 uses lever 112 (which itself includes a lever pad 110) to dispense material contained in the funnel Operation of the lever 112 is further described below.

The funnel 106 serves two purposes. First it creates a place to mount the canisters 104 and catches left over powder from the canister 104 when and if it is removed from the funnel. Second the funnel 106 provides creates a ¼″ channel 120 when assembled with the upper funnel mount 108. This channel 120 provides a slot for mounting the assembled dispensing unit to a wall mount or a stand as further described below.

FIG. 1B shows an exploded view of the dispenser 100 of FIG. 1. Again, the dispenser 100 comprises a canister lid 102, a refillable canister 104, a funnel 106, and an upper funnel mount 108. The exploded view of FIG. 1B also shows the means for assembling housing caps (118, 122) to the cylinder housing 114. The right housing cap 118 features through openings 130 which receive screws 132. The screws 132 pass through the through openings 130, through openings in the cylinder housing 114 (not shown) and are then threadably secured into screw bosses 134 in the left side housing cap 122. FIG. 1B also shows the lower spout trim 116 which is affixed to the lower end of the cylindrical housing 114.

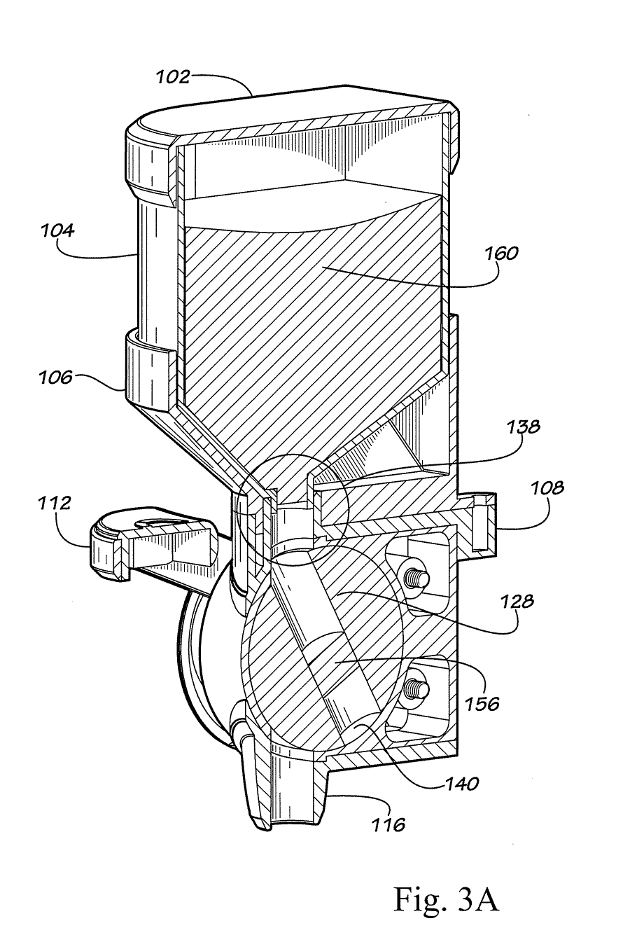

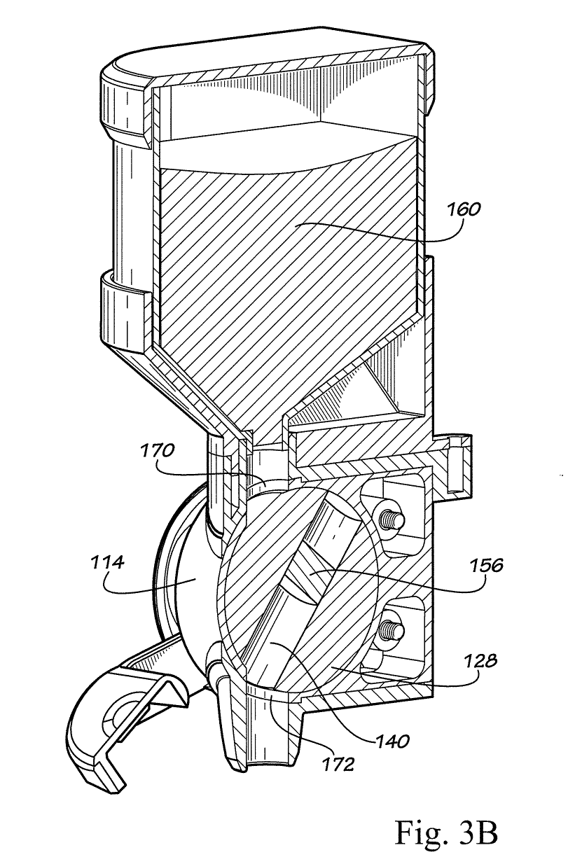

The upper funnel mount 108 cooperates with the funnel 106 and cylinder housing 114 to dispense material from the funnel to the housing. A bottom surface of the upper funnel mount 108 is glued to an upper surface of the cylinder housing 114 so it is permanently attached. The funnel 106, upper funnel mount 108, and housing 114 couple together as shown at 138 in FIG. 3A. The funnel 106 provides a “downspout” to guide the powder from the canister 104 into the dispensing cavity 140 of the cylinder part as seen in FIGS. 3A and 3B.

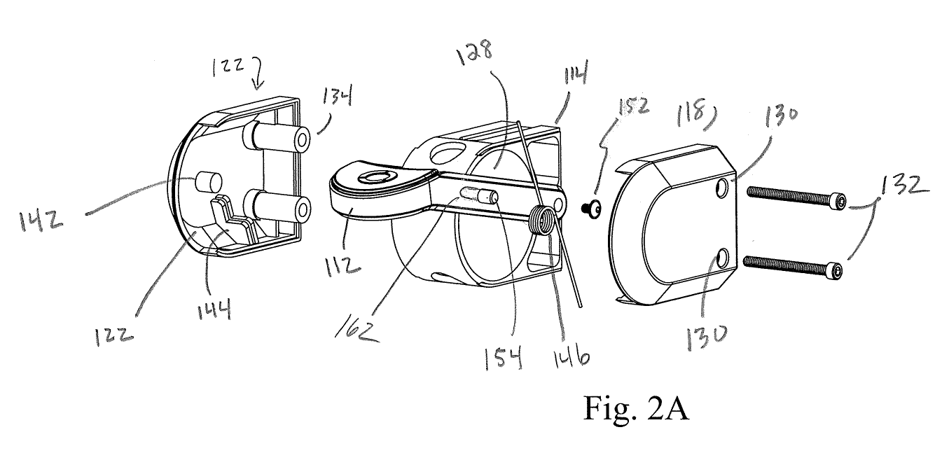

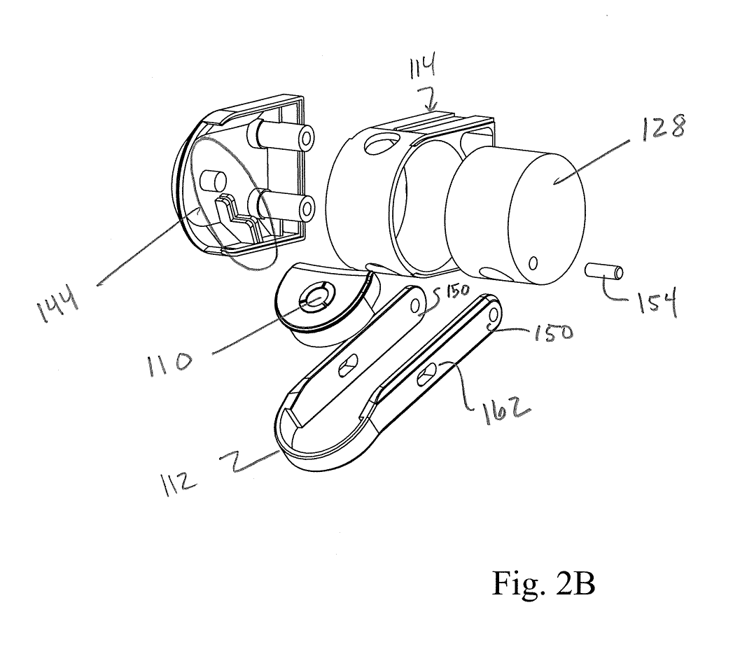

FIG. 2A shows a partially exploded view of the dispensing mechanism of the dispenser 100. As already mentioned above, the housing caps 118, 122 cap the cylinder housing 114 on the open ends to keep the cylinder 128 housed within cylinder housing from shifting left or right. The housing caps 118, 122 also provide bosses 134 and through holes 130 to screw the lower assembly together as already described above. On each interior wall of a housing cap is a round boss 142 to mount a 180 degree torsion spring with a spring rate of between 0.75 lbs to 1.1 lbs per spring. The interior of each housing also has a set of parallel walls 144 to trap one leg of the torsion spring and hold it stationary. In operation, the coil of the torsion spring 146 is also mounted on the lever spring pin 154 so that the lever 112 is held in upwardly deployed position (as seen in FIG. 3A). There are mirrored left and right versions of the torsion spring. Note that the interior wall of housing cap 118 is not visible in FIG. 2A.

FIG. 2A also shows the means for securing the lever 112 to the cylindrical housing 114. The lever comprises through openings (see 150, FIG. 2B) for receiving screws 152 which are then threadably secured into the cylindrical housing 114. In operational position, the lever may rotate up and down around the axis of the threadably secured screw 152. As the lever 112 moves up and down, the lever 112 rotates the cylinder (seen at 128 in FIG. 3B).

FIG. 2B shows the cylinder 128, lever spring pin 154, lever 112, lever pad 110 and housing 114 in exploded view. The cylinder 128 comprises a metal or equally hard plastic. The cylinder 128 has a hole drilled through the center to create a cavity (see 140 in FIGS. 3A and 3B). The cavity allows an adjustable cylinder plug part (see 156 in FIGS. 3A and 3B) to be mounted at varying heights inside the cavity thereby increasing or decreasing the volume of sweetener dispensed. Some sweeteners have a 1 gram serving size and others have a 3-4 gram serving size. It is critical that the diameter of the cylinder 128 be fractionally smaller (around 0.002″) than the cylinder housing 114. The cylinder 128 needs to spin freely inside the housing but cannot allow any powder grains to get in between the two parts.

Operation of the lever is further described with respect to FIGS. 2A and 2B. The lever 112 comprises the arm that is pressed down in order to dispense powder (see 160, FIGS. 3A & 3B). It has a pivot point on one end that is NOT concentric with the pivot axis of the cylinder 128. As noted below, the lever rotates about an axis of the threadably secured screws 152. The lever has a slot 162 cut in each arm so that the lever spring pin part 154 can pass through the slot 160 and engage the other end of the torsion spring allowing the torsion spring to push the lever 112 (and rotate the cylinder 128) back up to the “filling” position when the unit is at rest. The lever pin 154 is fixed to the cylinder 128. It passes through the slot 162 on the lever 112 and provides a surface for the torsion spring to press up on.

With continued reference to FIGS. 2A and 2B, the pivot point of the lever 112 and the slot 162 create a mechanical advantage when depressing the lever to dispense. Rotating the lever arm 42.5 degrees results in the cylinder 128 rotating 120 degrees moving from the “fill” to the “dispense” positions. This is important because a 1:1 relationship would result in a lever arm that blocked the dispensing of powder into a beverage. FIG. 3A shows the cylinder in “fill” position. FIG. 3B shows the cylinder in “dispense” position. Alternative embodiments include using multiple spur gears to create the same mechanical advantage. A larger gear may be fixed to the lever arm 112 that drives a smaller gear fixed to the cylinder 128 via an idler gear. This entire mechanism could also be driven by a motor to provide the rotation of the cylinder.

With reference to FIG. 3B, note that the cylindrical housing 114 has a filling hole 170 and a dispensing hole 172 drilled of equal diameters and on the same axis.

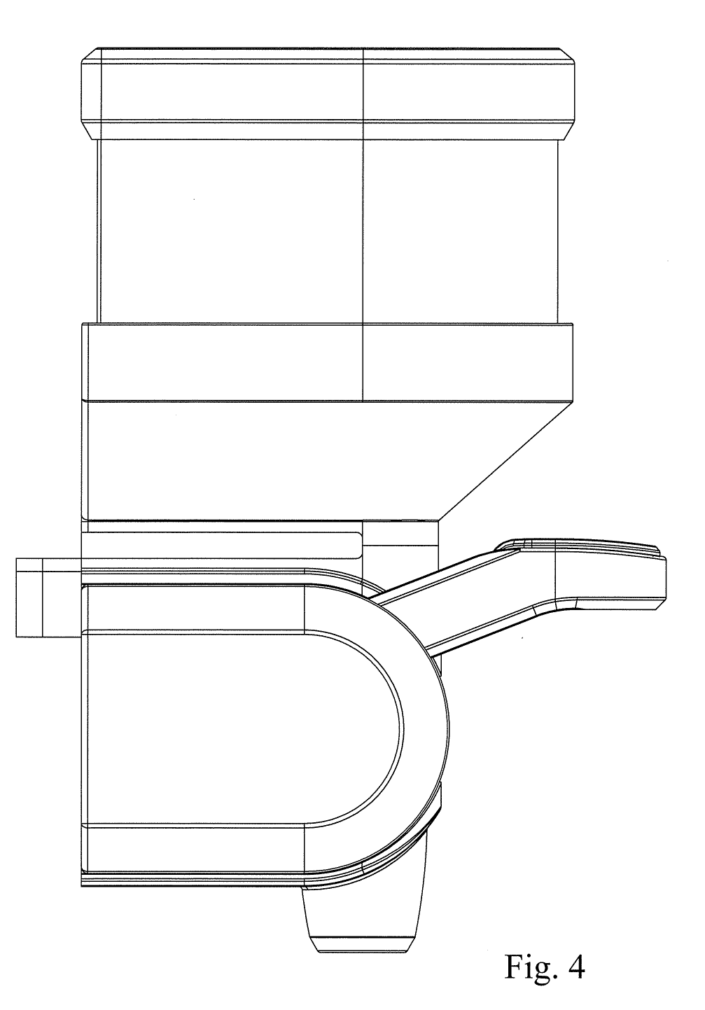

FIG. 4 is a left side view of a dispenser under an embodiment.

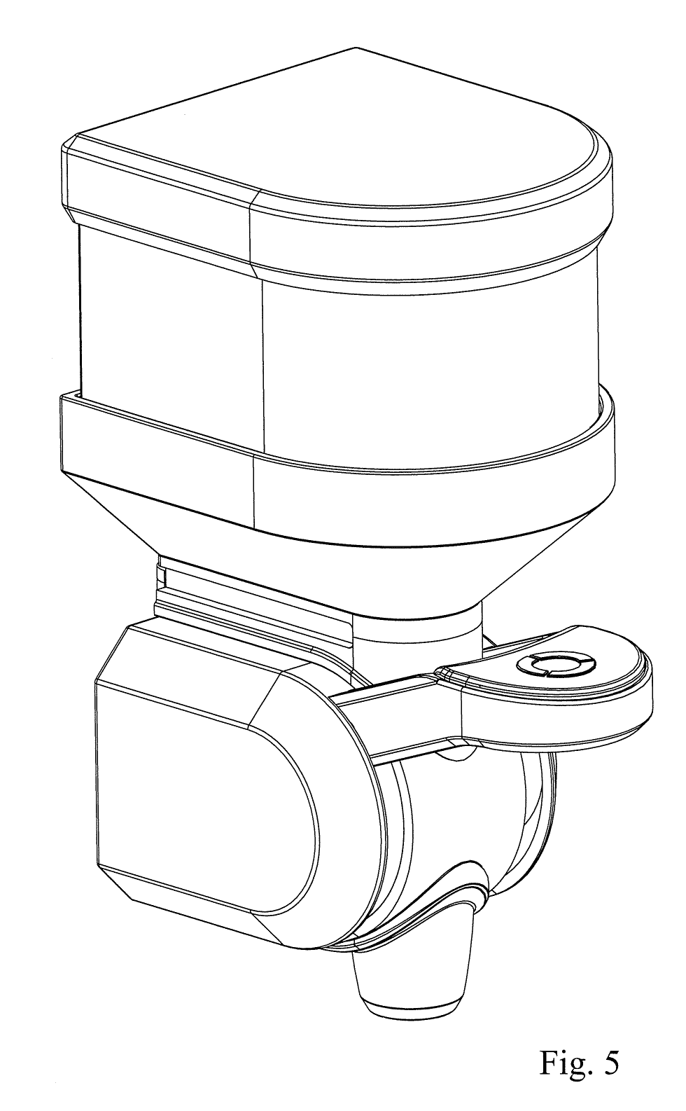

FIG. 5 is a left front perspective view of a dispenser under an embodiment.

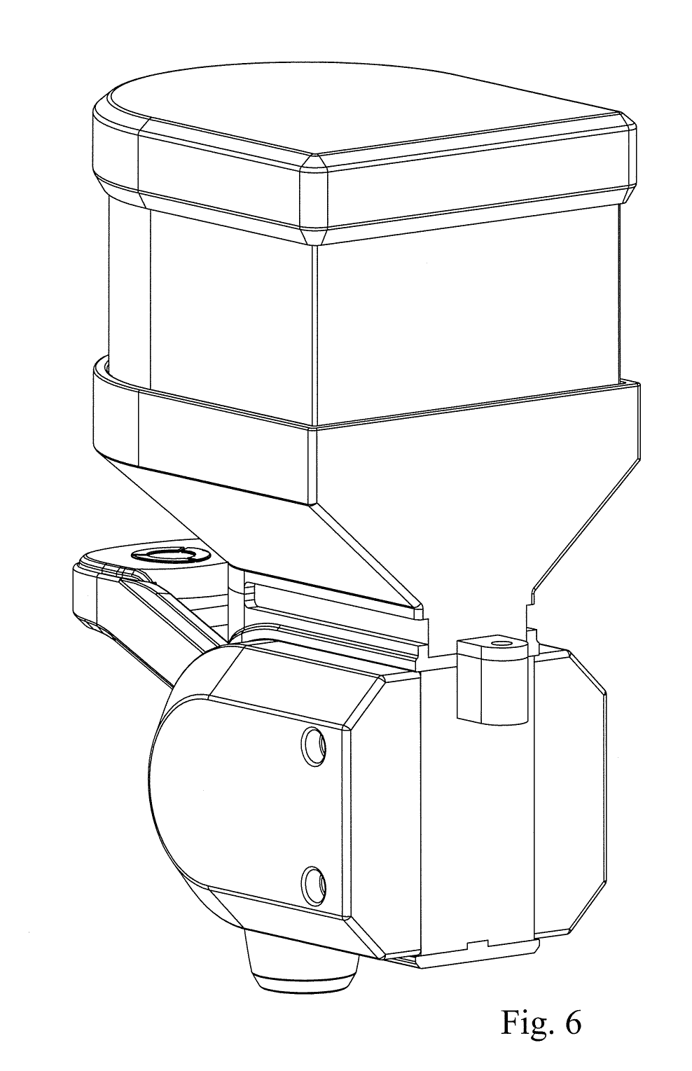

FIG. 6 is a back left perspective view of a dispenser under an embodiment.

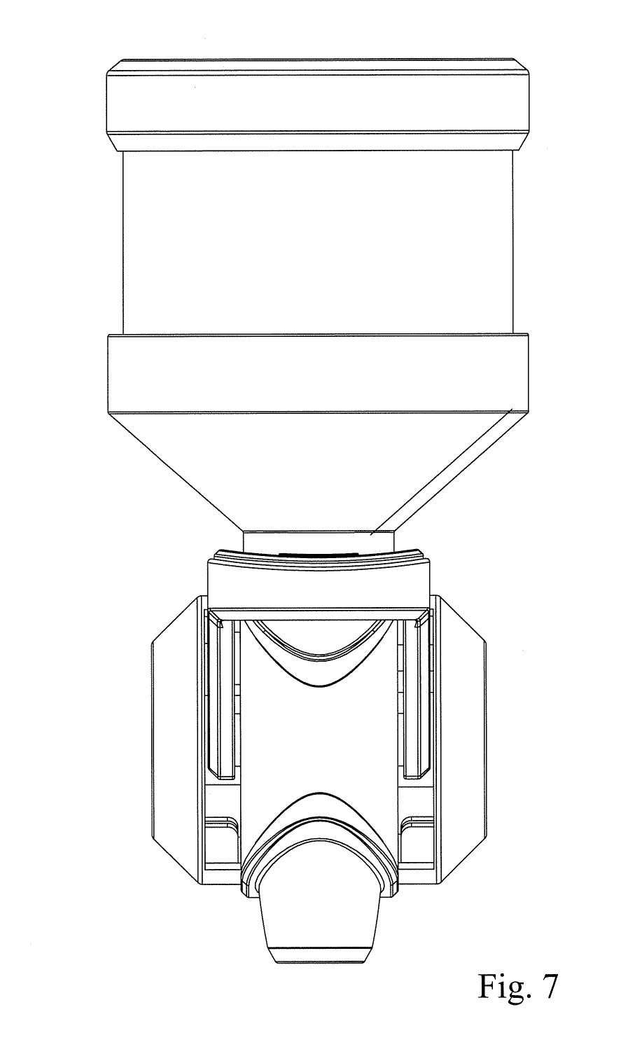

FIG. 7 is a front view of a dispenser under an embodiment.

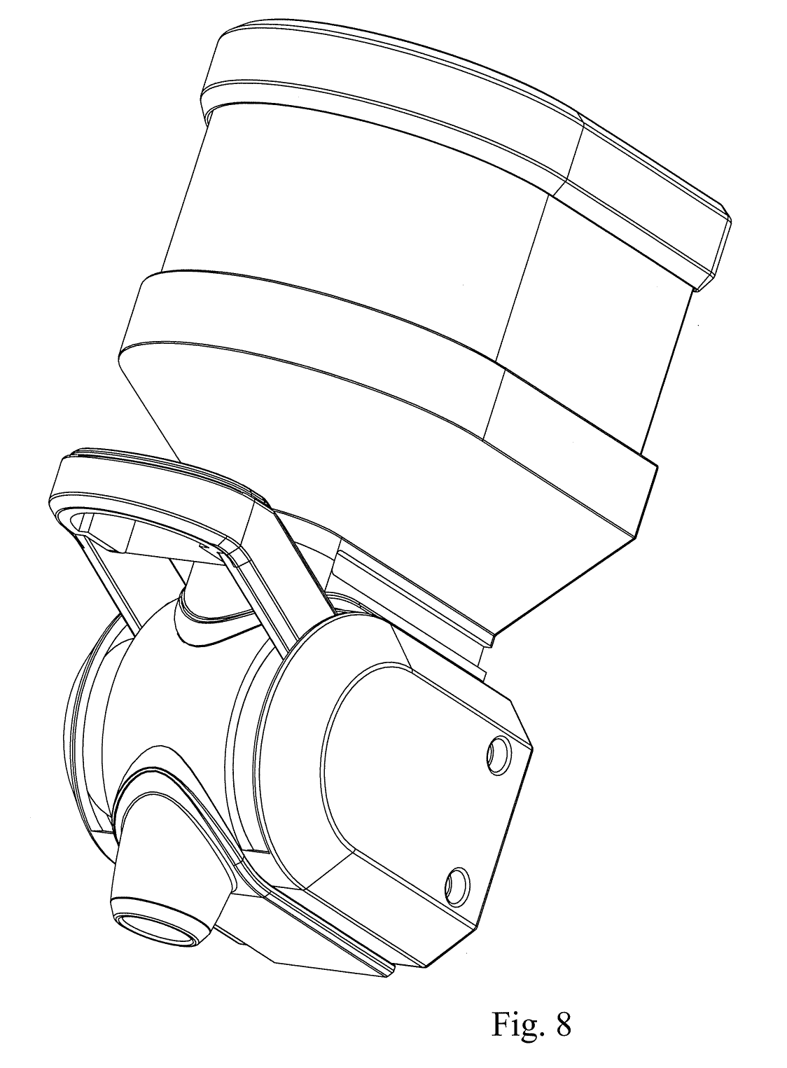

FIG. 8 is a front right perspective view of a dispenser under an embodiment.

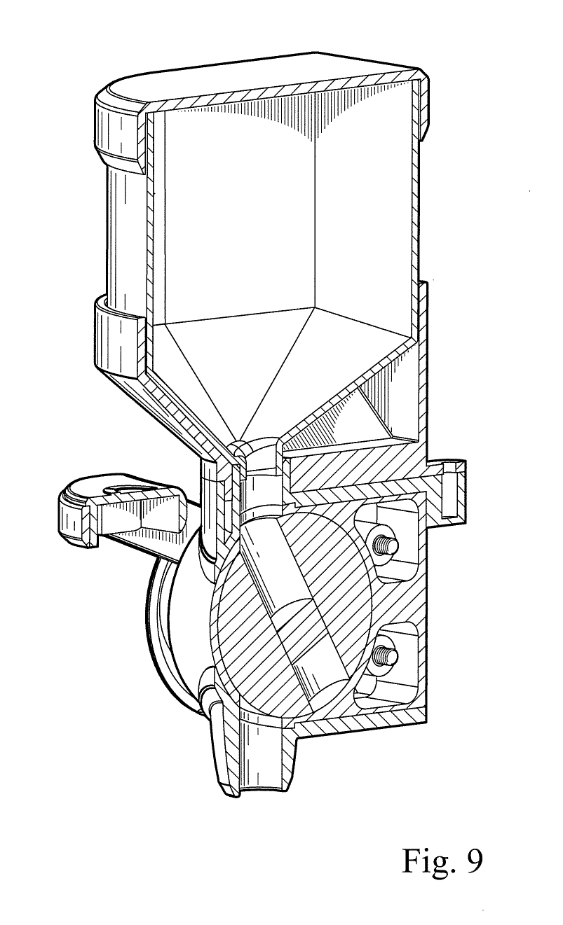

FIG. 9 is a cross sectional view of a dispenser under an embodiment.

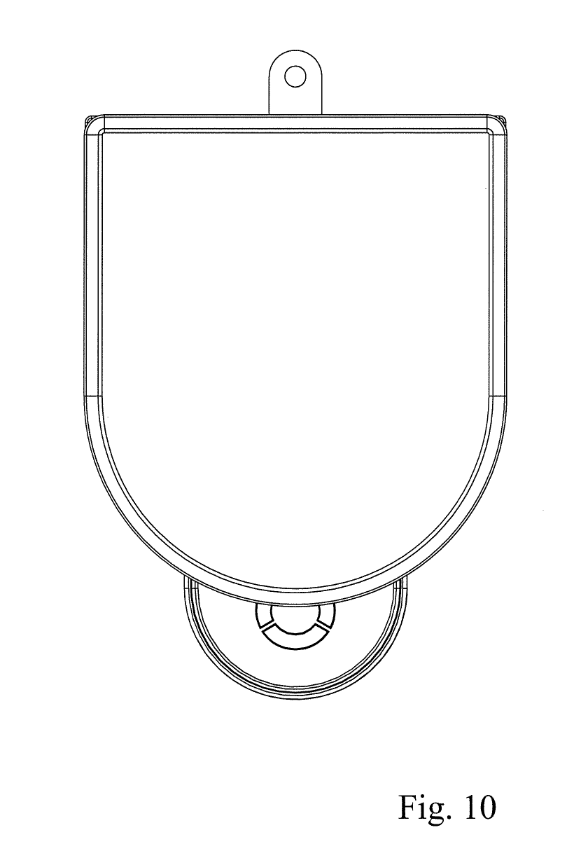

FIG. 10 is a top down view of a dispenser under an embodiment.

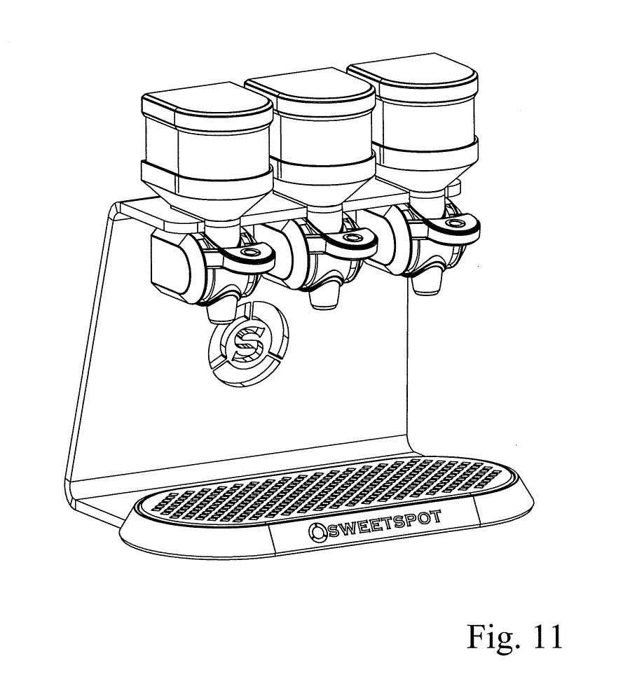

FIG. 11 is a front left perspective view of a plurality of dispensers mounted on a stand under an embodiment.

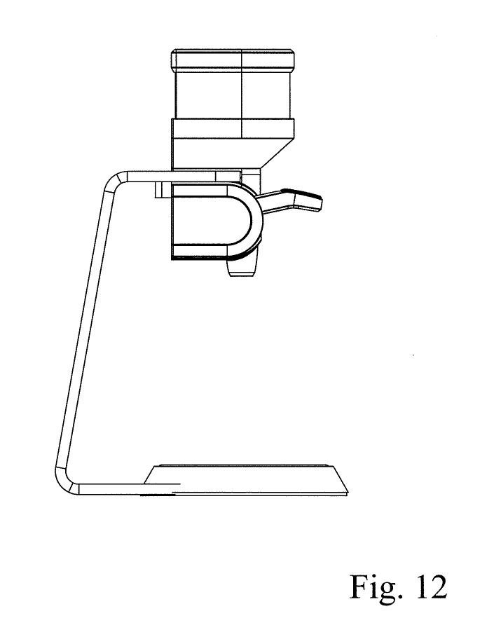

FIG. 12 is a left side view of a plurality of dispensers mounted on a stand under an embodiment.

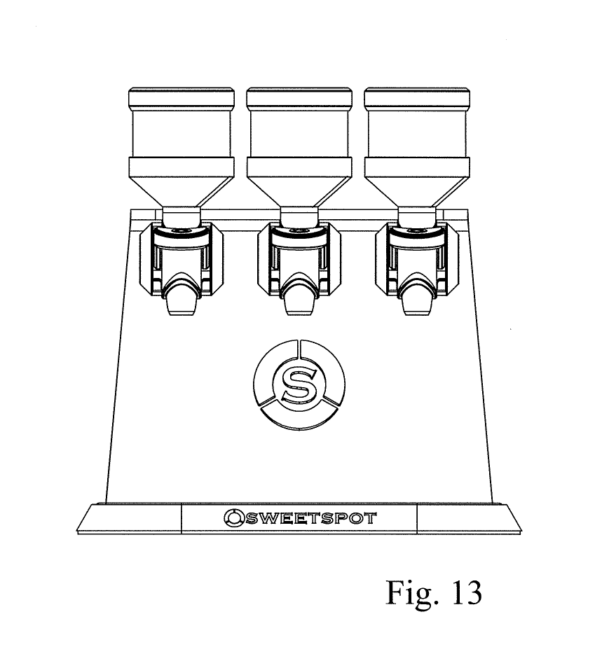

FIG. 13 is a front view of a plurality of dispensers mounted on a stand under an embodiment.

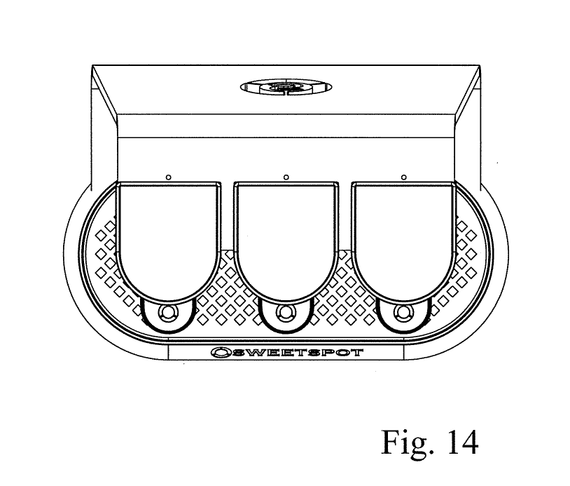

FIG. 14 is a top down view of a plurality of dispensers mounted on a stand under an embodiment.

Under one embodiment, a granular dispenser comprises a canister comprising a body having upper and lower ends, wherein the upper end is open for receiving a granular material, and the bottom end defines an opening for releasing the granular material. Under an embodiment, the granular dispenser may comprise a lid configured to cover the upper end of the canister, a funnel disposed below the bottom end and dimensioned to receive the bottom end, the funnel having an opening aligned with the opening of the bottom end, an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel. Under an embodiment, the granular dispenser includes a flange that extends from the upper funnel mount laterally from the aligned openings. Under such embodiment, a granular dispense may comprise a lever. Under such embodiment, a dispenser may include a cylinder residing below the funnel, the cylinder rotating about a horizontal axis in response to movement of the lever, and the cylinder having a bore there through that aligns with the opening in the bottom end of the canister and the opening in the funnel for receiving the granular material. The embodiment may comprise a cylinder housing having a bore that rotationally receives the cylinder, and that supports the flange. The embodiment may comprise a lower spout defining an opening below the cylinder housing, wherein the granular dispenser is configured such that rotation of the lever causes the bore of the cylinder to at least partially align with the opening in the bottom end of the canister and with the opening in the lower spout so that granular material may be gravitationally dispensed from the lower spout.

Under an embodiment, the granular dispenser further comprises a left housing cap residing on a left side of the cylinder housing, and a right housing cap residing on a right side of the cylinder housing, wherein the left and right housing caps cover the cylinder within the cylinder housing.

Under an embodiment, the granular dispenser further comprises a biasing member that causes the lever to be biased in a position such that the bore of the cylinder is out of alignment with the opening in the bottom end of the canister and with the opening in the lower spout so that granular material may not be dispensed from the lower spout.

Under an embodiment, the biasing member is a spring.

Under an embodiment, the spring causes the lever to be biased in a raised position, so that dispensing the granular material requires movement of the lever from its raised position to a lowered position.

Under an embodiment, the lever comprises a handle configured to rotate with the cylinder between raised and lowered positions, and a pad.

Under an embodiment, the spring comprises a central opening, and the lever of the handle comprises a pin opening, and the dispenser further comprises a pin received within the central opening of the spring and the pin opening in the lever such that rotation of the lever from its raised position to its lowered position acts against the biasing force of the spring.

Under an embodiment, the canister lid is configured to pivot above the canister body between a raised position in which granular material may be placed into the body, and a lowered position wherein the granular material is covered within the body.

Under an embodiment, the granular material is a sweetener.

Under an embodiment, the flange is integral to the upper funnel mount, the flange includes a vertical recess, the funnel includes a base that gravitationally rests on the flange, wherein the base also includes a vertical recess that aligns with the vertical recess in the flange, and a screw to be received in the aligned recesses.

Under an embodiment, the body of the canister is at least partially received in the funnel.

Under an embodiment, a sweetener dispensing system comprises a support stand and a plurality of sweetener dispensers supported by the support stand. Under an embodiment, each of the sweetener dispensers comprises a canister comprising a body having upper and lower ends, wherein the upper end is open for receiving a sweetener, and the bottom end defines an opening for gravitationally releasing the sweetener. Under an embodiment, each of the sweetener dispensers comprises a lid configured to cover the upper end of the canister. Under an embodiment, each of the sweetener dispensers comprises a funnel disposed below the bottom end and dimensioned to receive the bottom end, the funnel having an opening aligned with the opening of the bottom end. Under an embodiment, each of the sweetener dispensers comprises an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel. Under an embodiment, each of the sweetener dispensers comprises a flange that extends from the upper funnel mount laterally from the aligned openings. Under an embodiment, each of the sweetener dispensers comprises a lever. Under an embodiment, each of the sweetener dispensers comprises a cylinder residing below the funnel, the cylinder rotating about a horizontal axis in response to movement of the lever, and the cylinder having a bore there through that aligns with the opening in the bottom end of the canister and the opening in the funnel for receiving the sweetener. Under an embodiment, each of the sweetener dispensers comprises a cylinder housing having a bore that rotationally receives the cylinder, and that supports the flange. Under an embodiment, each of the sweetener dispensers comprises a lower spout defining an opening below the cylinder housing, wherein each sweetener dispenser is configured such that rotation of the lever causes the bore of the respective cylinder to at least partially align with the opening in the bottom end of the corresponding canister and with the opening in the corresponding lower spout so that sweetener may be gravitationally dispensed from the lower spout.

Under an embodiment, each of the sweetener dispensers comprises further comprises a biasing member that causes the lever to be biased in a position such that the bore of the cylinder is out of alignment with the opening in the bottom end of the canister and with the opening in the lower spout so that granular material may not be dispensed from the lower spout. Under an embodiment, each of the sweetener dispensers further comprises a left housing cap residing on a left side of the cylinder housing, and a right housing cap residing on a right side of the cylinder housing, wherein the left and right housing caps cover the cylinder within the cylinder housing.

Under an embodiment, the biasing member is a spring that causes the lever to be biased in a raised position, so that dispensing the sweetener requires movement of the lever from its raised position to a lowered position.

Under an embodiment, the body of the canister is at least partially received in the funnel, the spring comprises a central opening, the lever comprises a pin opening along a handle, and the dispenser further comprises a pin received within the central opening of the spring and the pin opening in the lever such that rotation of the lever from its raised position to its lowered position acts against the biasing force of the spring.

Under an embodiment, the stand comprises a free standing base having a plurality of openings supported above a surface, wherein each opening is dimensioned to receive the funnel of a corresponding dispenser.

Under an embodiment, the stand comprises a bracket dimensioned to be secured to the wall, the bracket having a plurality of openings, with each opening being dimensioned to receive the funnel of a corresponding dispenser.

A method of dispensing a sweetener under an embodiment comprises providing a support stand. A method of an embodiment includes providing a plurality of sweetener dispensers. Under such embodiment each of the sweetener dispensers comprises a canister comprising a body having upper and lower ends, wherein the upper end is open for receiving a sweetener, and the bottom end defines an opening for gravitationally releasing the sweetener. Under such embodiment each of the sweetener dispensers comprises, a lid is configured to cover the upper end of the canister. Under such embodiment each of the sweetener dispensers comprises a funnel disposed below the bottom end and dimensioned to receive the bottom end, the funnel having an opening aligned with the opening of the bottom end. Under such embodiment each of the sweetener dispensers comprises an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel. Under such embodiment each of the sweetener dispensers comprises a flange that extends from the upper funnel mount laterally from the aligned openings. Under such embodiment each of the sweetener dispensers comprises a lever. Under such embodiment each of the sweetener dispensers comprises a cylinder residing below the funnel, the cylinder rotating about a horizontal axis in response to movement of the lever, and the cylinder having a bore there through that aligns with the opening in the bottom end of the canister and the opening in the funnel for receiving the sweetener. Under such embodiment each of the sweetener dispensers comprises a cylinder housing having a bore that rotationally receives the cylinder, and that supports the flange. Under such embodiment each of the sweetener dispensers comprises a lower spout defining an opening below the cylinder housing. A method of an embodiment places the funnel of each dispenser into a corresponding opening along the stand such that the dispensers are supported by the stand. A method of an embodiment rotates the lever of a dispenser in order to dispense a sweetener.

A method of an embodiment includes wherein rotation of the lever causes the bore of the respective cylinder to at least partially align with the opening in the bottom end of the corresponding canister and with the opening in the corresponding lower spout so that sweetener may be gravitationally dispensed from the lower spout.

A method of an embodiment includes wherein each of the dispensers further comprises a biasing member that causes the lever to be biased in a position such that the bore of the cylinder is out of alignment with the opening in the bottom end of the canister and with the opening in the lower spout so that granular material may not be dispensed from the lower spout, a left housing cap residing on a left side of the cylinder housing, and a right housing cap residing on a right side of the cylinder housing, wherein the left and right housing caps cover the cylinder within the cylinder housing.

A method of an embodiment includes wherein the biasing member is a spring that causes the lever to be biased in a raised position, so that dispensing the sweetener requires movement of the lever from its raised position to a lowered position.

A method of an embodiment includes wherein the body of the canister is at least partially received in the funnel, the spring comprises a central opening, the lever comprises a pin opening along a handle, and the dispenser further comprises a pin received within the central opening of the spring and the pin opening in the lever such that rotation of the lever from its raised position to its lowered position acts against the biasing force of the spring.

A method of an embodiment includes wherein the stand comprises a free standing base having a plurality of openings supported above a surface, with each opening in the stand being dimensioned to receive the funnel of a corresponding dispenser.

A method of an embodiment includes wherein the stand comprises a bracket and wherein the method further comprises securing the bracket to a wall, and placing the funnel of a dispenser into a corresponding opening in the bracket.

A method of an embodiment includes labeling each canister with the identity of the sweetener in the body of the corresponding canister, removing the lid of each canister; and filling each canister with the appropriate sweetener.

As seen in FIG. 11 above, the stand includes a base with drip tray, a vertical portion and a return portion. The return portion includes three recessed slots. The sides of the recessed slots slide into channel 120 of the upper funnel mount 108 as already described above regarding FIG. 1. Also there is a tab on the backside of the funnel 106 that corresponds with a threaded insert on upper funnel mount 108. When installed on a stand or wall mount a single screw goes through the mounting plate then through the funnel tab and final into the threaded insert in the upper funnel mount, preventing it from moving or being removed accidently.

Additional embodiments include an electronic interface for control of the dispensing lever 112. A user selects a lever which corresponds to a desired sweetener. The user then presses the lever 112 for a single serving, twice for two servings and so on. Under an alternative embodiment, an electronically controlled lever may respond to a user input. For example. a housing may entirely conceal the dispensing mechanism The housing may obscure or hide the dispenser funnel 106 as well. A front of the housing may feature an electronic interface providing users various sweetener options. For example, the interface may provide an initial choice of sweetener. Thereafter a user may select serving size. The interface is coupled to at least one processor in the housing running one or more applications for implementing the functionality of the touchscreen and for implementing a control system for manipulating the dispensing mechanism (lever) of the dispenser.

Under an alternative embodiment, the funnel 106 may be translucent to indicate when sugar/sweetener/condiment is getting low. The canister 104 itself may also have a translucent re-fill indicator line.

Under an alternative embodiment canisters 104 may be self closing. If a user were to prematurely lift a canister up from the funnel (before its emptied) the canister would self close, whereby there would be less mess.

Under an alternative embodiment, the dispenser 100 may be used to dispense other materials including condiments, salt, garlic powder, candy-toppings (e.g. M&M's).

Under an alternative embodiment, a plastic tube insert may be dropped into the cylinder cavity 140 and secured by an indentation in the housing. Such tubes may then define serving sizes (e.g. a 1 gram plastic tube vs a 3 gram plastic tube).

Under an alternative embodiment, a dispenser 100 may allow quick adjustment to the volume of the cavity. A quick adjust/dosing mechanism may adjust to the largest volume the cavity 140 holds (say 10 grams), or, the adjustment mechanism may be a turn dial that acts like a measuring guide. For example, the turn dial may say 5× for ¼ cup which means press lever 112 5 times for a ¼ cup.

Under an alternative embodiment, an indentation/indicator to the very front of the cylinder housing 114 (in an area above the lower spout trim) may be provided. If a user only pushes lever to this “halfway” point, the dispenser will provide a half serving size at that point. If a user pushes the lever fully down the dispenser provides the full serving.

Under an alternative embodiment, the canister lid 102 may comprise a lock or simple security latch to prevent unauthorized openings.

Under an alternative embodiment, the lever 112 may comprise a wishbone “Y” design. If the lever 112 looked like a wishbone, the top part of the “Y” would be anchored to the housing, but the portion of the top part would converge to a single point. A user would depress the lever pad 110 at this point.

Under an alternative embodiment, a drip tray with rubberized coating is provided underneath the dispenser. This alternative coating would stop the sugar from ricocheting off the plastic.

Artificial Sweeteners are made with an anti-caking agent (anti-clumping). However, sugar really has a tendency to clump (as well as other condiments). Under an alternative embodiment, a mechanism may be implemented in the housing/funnel/chamber of dispenser to break up or crush such clumps. The lid, canister or funnel may also under one embodiment include anti moisture agents.

While it will be apparent that the inventions herein described are well calculated to achieve the benefits and advantages set forth above, it will be appreciated that the inventions are susceptible to modification, variation and change without departing from the spirit thereof.

We claim:

1. A granular dispenser, comprising:
a canister comprising a body having upper and lower ends, wherein the upper end is open for receiving a granular material, and the bottom end defines an opening for releasing the granular material;
a lid configured to cover the upper end of the canister;
a funnel disposed below the bottom end and dimensioned to receive the bottom end, the funnel having an opening aligned with the opening of the bottom end;
an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel;
a flange that extends from the upper funnel mount laterally from the aligned openings;
a lever;
a cylinder residing below the funnel, the cylinder rotating about a horizontal axis in response to movement of the lever, and the cylinder having a bore there through that aligns with the opening in the bottom end of the canister and the opening in the funnel for receiving the granular material;
a cylinder housing having a bore that rotationally receives the cylinder, and that supports the flange; and
a lower spout defining an opening below the cylinder housing;
wherein the granular dispenser is configured such that rotation of the lever causes the bore of the cylinder to at least partially align with the opening in the bottom end of the canister and with the opening in the lower spout so that granular material may be gravitationally dispensed from the lower spout.

2. The granular dispenser of claim 1, further comprising:
a left housing cap residing on a left side of the cylinder housing; and
a right housing cap residing on a right side of the cylinder housing; and
wherein the left and right housing caps cover the cylinder within the cylinder housing.

3. The granular dispenser of claim 1, further comprising:
a biasing member that causes the lever to be biased in a position such that the bore of the cylinder is out of alignment with the opening in the bottom end of the canister and with the opening in the lower spout so that granular material may not be dispensed from the lower spout.

4. The granular dispenser of claim 3, wherein the biasing member is a spring.

5. The granular dispenser of claim 4, wherein the spring causes the lever to be biased in a raised position, so that dispensing the granular material requires movement of the lever from its raised position to a lowered position.

6. The granular dispenser of claim 4, wherein the lever comprises:
a handle configured to rotate with the cylinder between raised and lowered positions; and
a pad.

7. The granular dispenser of claim 6, wherein:
the spring comprises a central opening;
the lever of the handle comprises a pin opening; and
the dispenser further comprises a pin received within the central opening of the spring and the pin opening in the lever such that rotation of the lever from its raised position to its lowered position acts against the biasing force of the spring.

8. The granular dispenser of claim 6, wherein:
the canister lid is configured to pivot above the canister body between a raised position in which granular material may be placed into the body, and a lowered position wherein the granular material is covered within the body.

9. The granular dispenser of claim 8, wherein the granular material is a sweetener.

10. The granular dispenser of claim 1, wherein:
the flange is integral to the upper funnel mount;
the flange includes a vertical recess;
the funnel includes a base that gravitationally rests on the flange, wherein the base also includes a vertical recess that aligns with the vertical recess in the flange; and
a screw to be received in the aligned recesses.

11. The granular dispenser of claim 1, wherein the body of the canister is at least partially received in the funnel.

12. A sweetener dispensing system, comprising:
a support stand; and
a plurality of sweetener dispensers supported by the support stand; and
wherein each of the sweetener dispensers comprises:
a canister comprising a body having upper and lower ends, wherein the upper end is open for receiving a sweetener, and the bottom end defines an opening for gravitationally releasing the sweetener;
a lid configured to cover the upper end of the canister;
a funnel disposed below the bottom end and dimensioned to receive the bottom end, the funnel having an opening aligned with the opening of the bottom end;
an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel;
a flange that extends from the upper funnel mount laterally from the aligned openings;
a lever;
a cylinder residing below the funnel, the cylinder rotating about a horizontal axis in response to movement of the lever, and the cylinder having a bore there through that aligns with the opening in the bottom end of the canister and the opening in the funnel for receiving the sweetener;
a cylinder housing having a bore that rotationally receives the cylinder, and that supports the flange; and
a lower spout defining an opening below the cylinder housing;
wherein each sweetener dispenser is configured such that rotation of the lever causes the bore of the respective cylinder to at least partially align with the opening in the bottom end of the corresponding canister and with the opening in the corresponding lower spout so that sweetener may be gravitationally dispensed from the lower spout.

13. The sweetener dispensing system of claim 12, wherein each of the dispensers further comprises:
a biasing member that causes the lever to be biased in a position such that the bore of the cylinder is out of alignment with the opening in the bottom end of the canister and with the opening in the lower spout so that granular material may not be dispensed from the lower spout;
a left housing cap residing on a left side of the cylinder housing; and
a right housing cap residing on a right side of the cylinder housing;
wherein the left and right housing caps cover the cylinder within the cylinder housing.

14. The sweetener dispensing system of claim 13, wherein the biasing member is a spring that causes the lever to be biased in a raised position, so that dispensing the sweetener requires movement of the lever from its raised position to a lowered position.

15. The sweetener dispensing system of claim 14, wherein:
the body of the canister is at least partially received in the funnel;
the spring comprises a central opening;
the lever comprises a pin opening along a handle; and
the dispenser further comprises a pin received within the central opening of the spring and the pin opening in the lever such that rotation of the lever from its raised position to its lowered position acts against the biasing force of the spring.

16. The sweetener dispensing system of claim 12, wherein the stand comprises a free standing base having a plurality of openings supported above a surface, wherein each opening is dimensioned to receive the funnel of a corresponding dispenser.

17. The sweetener dispensing system of claim 12, wherein the stand comprises a bracket dimensioned to be secured to the wall, the bracket having a plurality of openings, with each opening being dimensioned to receive the funnel of a corresponding dispenser.

18. A method of dispensing a sweetener comprising:
providing a support stand;
providing a plurality of sweetener dispensers, wherein each of the sweetener dispensers comprises:
a canister comprising a body having upper and lower ends, wherein the upper end is open for receiving a sweetener, and the bottom end defines an opening for gravitationally releasing the sweetener;
a lid configured to cover the upper end of the canister;
a funnel disposed below the bottom end and dimensioned to receive the bottom end, the funnel having an opening aligned with the opening of the bottom end;
an upper funnel mount having a first lip for supporting a shoulder on the bottom end of the canister, a second lip for concentrically supporting a shoulder around the opening of the funnel, and an opening that aligns with the aligned openings in the bottom end of the canister and in the funnel;
a flange that extends from the upper funnel mount laterally from the aligned openings;
a lever;
a cylinder residing below the funnel, the cylinder rotating about a horizontal axis in response to movement of the lever, and the cylinder having a bore there through that aligns with the opening in the bottom end of the canister and the opening in the funnel for receiving the sweetener;
a cylinder housing having a bore that rotationally receives the cylinder, and that supports the flange; and
a lower spout defining an opening below the cylinder housing;
placing the funnel of each dispenser into a corresponding opening along the stand such that the dispensers are supported by the stand;
rotating the lever of a dispenser in order to dispense a sweetener.

19. The method of claim 18, wherein rotation of the lever causes the bore of the respective cylinder to at least partially align with the opening in the bottom end of the corresponding canister and with the opening in the corresponding lower spout so that sweetener may be gravitationally dispensed from the lower spout.

20. The method of claim 19, wherein each of the dispensers further comprises:
a biasing member that causes the lever to be biased in a position such that the bore of the cylinder is out of alignment with the opening in the bottom end of the canister and with the opening in the lower spout so that granular material may not be dispensed from the lower spout;
a left housing cap residing on a left side of the cylinder housing; and
a right housing cap residing on a right side of the cylinder housing;
wherein the left and right housing caps cover the cylinder within the cylinder housing.

21. The method of claim 20, wherein the biasing member is a spring that causes the lever to be biased in a raised position, so that dispensing the sweetener requires movement of the lever from its raised position to a lowered position.

22. The method of claim 21, wherein:
the body of the canister is at least partially received in the funnel;
the spring comprises a central opening;
the lever comprises a pin opening along a handle; and
the dispenser further comprises a pin received within the central opening of the spring and the pin opening in the lever such that rotation of the lever from its raised position to its lowered position acts against the biasing force of the spring.

23. The method of claim 21, wherein the stand comprises a free standing base having a plurality of openings supported above a surface, with each opening in the stand being dimensioned to receive the funnel of a corresponding dispenser.

24. The method of claim 23, wherein:
the stand comprises a bracket; and
the method further comprises:
securing the bracket to a wall; and
placing the funnel of a dispenser into a corresponding opening in the bracket.

25. The method of claim 18, further comprising:
labeling each canister with the identity of the sweetener in the body of the corresponding canister;
removing the lid of each canister; and
filling each canister with the appropriate sweetener.
